(19) United States
(12) Patent Application Publication
(10) Pub. No.: US 2002/0192833 A1
(43) Pub. Date: Dec. 19, 2002

(54) Method and apparatus for detecting the presence of a fluid on a test strip

(76) Inventors: Victor Pan, Fremont, CA (US); John Lemke, Pleasanton, CA (US); Harshad I. Patel, Fremont, CA (US); Philip Cizdziel, San Jose, CA (US)

Correspondence Address: BOZICEVIC, FIELD & FRANCIS LLP, 200 MIDDLEFIELD RD, SUITE 200, MENLO PARK, CA, 94025, US

(21) Appl. No.: 10/228,868

(22) Filed: Aug. 26, 2002

Related U.S. Application Data
(62) Division of application No. 09/630,340, filed on Jul. 31, 2000.

(51) Int. Cl. G01N 21/00

(52) U.S. Cl. 436/164; 436/169; 422/57; 422/82.05

(57) ABSTRACT

Methods and devices are provided for detecting the application of a fluid sample onto a test strip surface when the test strip is inserted into an optical meter. In the subject methods, reflectance data is obtained from a portion of the optical meter in which the sample application region of the test strip is located, where the reflectance data covers a period of time ranging from a point at least prior to application of the sample to the strip to a point following application of the sample to the strip. The presence of the fluid sample on the test strip is then determined from the reflectance data. Also provided are optical meters that include optical means for obtaining reflectance data, where these optical means include at least an irradiation source and a light detector. The subject methods and devices find use with a variety of test strips, and are particularly suited for use with test strips that include a fluid movement means, such as a compressible bladder.

### CROSS-REFERENCE

This application is a divisional application of Ser. No. 09/630,340, filed Jul. 31, 2000, which is incorporated herein by reference in its entirety and to which application we claim priority under 35 USC §120.

### INTRODUCTION

1. Field of the Invention

The field of this invention is fluidic medical diagnostic devices for measuring the concentration of an analyte in or a property of a biological fluid.

2. Description of the Specific Embodiments

A variety of medical diagnostic procedures involve tests on biological fluids, such as blood, urine, or saliva, and are based on a change in a physical characteristic of such a fluid or an element of the fluid, such as blood serum. The characteristic can be an electrical, magnetic, fluidic, or optical property. When an optical property is monitored, these procedures may make use of a transparent or translucent device to contain the biological fluid and a reagent. A change in light absorption, reflection, or scattering of the fluid can be related to an analyte concentration in, or property of, the fluid.

Of increasing use in many of the above described diagnostic procedures is the use of assay systems made up of disposable test cards or strips and meters for reading these strips. In many of the test cards or strips employed in these systems, fluid is introduced into the strip at one location, e.g. a sample application site, but analyzed at another, e.g. a measurement site. In such devices, movement of the introduced fluid from the sample application site to the measurement site is necessary. As such, these devices require a means for moving fluid from the sample application site to the measurement site.

In one class of fluidic test cards or strips that find use in the above described assay systems, fluid is moved through the device from the site of introduction by negative pressure, where the negative pressure is typically provided by a compressible bladder. Such devices include those described in U.S. Pat. No. 3,620,676; U.S. Pat. No. 3,640,267 and EP 0 803 288. In these types of devices, the bladder must be compressed prior to application of the sample to the sample application site of the test strip and then decompressed following application of the sample to the sample application site.

Of interest for use in the above described systems would be a meter that is capable of automatically actuating the bladder of a test strip in a correct and reproducible manner during use. As such, of interest is the development of a meter that is capable of identifying the application of a fluid sample onto a test strip and actuating a bladder in a correct manner in response thereto.

Relevant Literature

References of interest include: U.S. Pat. Nos. 3,620,676; 3,640,267; 4,088,448; 4,420,566; 4,426,451; 4,868,129; 5,049,487; 5,104,813; 5,230,866; 5,627,04; 5,700,695; 5,736,404; 5,208,163; 5,708,278 and European Patent Application EP 0 803 288.

### SUMMARY OF THE INVENTION

Methods and devices are provided for detecting the application of a fluid sample onto a test strip. In the subject methods, reflectance data is obtained from a portion of an optical meter in which the sample application region of the test strip is located, where the reflectance data covers a period of time ranging from a point at least prior to application of the sample to the strip to a point following application of the sample to the strip. The application of the fluid sample onto the test strip is then determined from the reflectance data. Also provided are optical meters that include optical means for obtaining reflectance data, where these optical means include at least an irradiation source and a light detector. The subject methods and devices find use with a variety of test strips, and are particularly suited for use with test strips that include a fluid movement means, such as a compressible bladder.

### BRIEF DESCRIPTION OF THE FIGURES

FIG. 1 is a plan view of a test strip with which the subject methods and devices find use.

FIG. 2 is an exploded view of the device of FIG. 1.

FIG. 3 is a perspective view of the device of FIG. 1.

FIG. 4 is a schematic of a meter for use with a device of this invention.

FIG. 5 is a graph of data that is used to determine PT time.

FIGS. 6A to 6E provide a sequential representation of the sample application detection method of the subject invention.

### DESCRIPTION OF THE SPECIFIC EMBODIMENTS

Methods and devices are provided for detecting the application of a fluid sample onto a test strip. In the subject methods, reflectance data is obtained from a portion of an optical meter in which the sample application region of the test strip is located, where the reflectance data covers a period of time ranging from a point at least prior to application of the sample to the strip to a point following application of the sample to the strip. The application of the fluid sample onto the test strip surface is then determined from the reflectance data. Also provided are optical meters that include optical means for obtaining reflectance data, where these optical means include at least an irradiation source and a light detector. The subject methods and devices find use with a variety of test strips, and are particularly suited for use with test strips that include a fluid movement means, such as a compressible bladder. In further describing the subject invention, the subject methods will be discussed first in greater detail followed by a description of the assay systems and components thereof that are used to practice the subject methods.

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, singular references include the plural, unless the context clearly dictates otherwise. Unless defined otherwise, all technical and scientific terms used herein have the same meaning as commonly understood to one of ordinary skill in the art to which this invention belongs.

Methods

As summarized above, the subject invention provides methods for detecting the application of a fluid sample onto a test strip surface when the test strip is placed in a meter, generally an optical meter. In other words, the subject methods provide a means for determining the application of a fluid sample to a surface of a test strip. As such, the subject methods are at least able to provide data regarding whether or not a fluid sample has been placed onto an application site of a test strip when the test strip is present in an optical meter. In many embodiments, the subject methods are also capable of detecting the application of a minimal or threshold amount of sample to the test strip surface, and in certain embodiments are capable of determining the amount of fluid that has been applied to the test strip.

In practicing the subject methods, reflectance data from the test strip is first obtained, where the reflectance data is then employed to at least determine whether sample has been applied to the test strip, where the reflectance data often yield information concerning whether a threshold amount of sample has been applied to the test strip surface. By reflectance data is meant a series of reflectance values obtained over a period of time. By reflectance value is meant an observed amount of reflected light, where the reflected light may be specular and/or diffusely reflected light, and is often both specular and diffusely reflected light.

The period of time over which the reflectance values are determined in order to obtain the requisite reflectance data at least ranges from a point prior to application of sample to the surface of a test strip to a point following application of the sample to a test strip, where in certain embodiments the period of time commences following introduction of the test strip into the optical meter and in certain other embodiments the period of time ranges from a point prior to introduction of the test strip into the optical meter to a point after application of the sample to the test strip present in the meter. As such, the period of time over which reflectance values are measured in obtaining the requisite reflectance data generally ranges from about 1 minute to 2 minutes, usually from about 20 seconds to 30 seconds and more usually from about 3 second to 5 seconds. In obtaining the requisite reflectance data, reflectance values may be obtained periodically or substantially continuously, if not continuously, during the period of time. Where the reflectance values are obtained periodically, these values will be obtained a minimum number of times, where the minimum number is generally at least about 1 reading per second, usually at least about 2 readings per second and more usually at least about 4 readings per second. In many of these embodiments, the number of reflectance values that are obtained over a given period of time ranges from about 60 to 120, usually from about 40 to 60 and more usually from about 12 to 20.

The above described reflectance data may be obtained using any convenient protocol. In many embodiments of the subject invention, the reference data is obtained by irradiating a region of the optical meter occupied by the sample application site of the test strip when inserted into the meter and detecting reflected light, both specular and diffuse, from the region over the desired period of time. In these protocols, the specific region of the optical meter that is irradiated is a region of the optical meter occupied by a bottom surface of the test strip opposite the sample application site when the strip inserted into the meter is irradiated. The region is generally irradiated with light over a narrow range of wavelengths. In many embodiments, the wavelengths of light that are used to irradiate the region of the optical meter ranges from about 400 nm to 700 nm, usually from about 500 nm to 640 nm and more usually from about 550 nm to 590 nm.

As mentioned above, in obtaining the reflectance data, one may periodically obtain reflectance values over the above described period of time or obtain reflectance values substantially continuously, if not continuously, over the above described period of time. As mentioned above, the period of time over which reflectance values are obtained in order to produce the requisite reflectance data ranges from a point prior to insertion of the test strip into the meter to a point following application of the sample to the application site of the test strip inserted into the meter. In these embodiments, the following protocol is generally employed.

First, the region of the optical meter occupied by the application site of the test strip is irradiated with light over a narrow range of wavelengths and reflected light (or generally the absence thereof) is detected one or more times, including continuously, during this first step. The length of time for this first step ranges from about 250 ms to I second, usually from about 250 ms to 750 ms and more usually from about 250 ms to 500 ms. Next, a test strip is inserted into the meter while the portion of the meter continues to irradiated and reflected light from the bottom surface of the test strip is detected one or more times, including continuously, during this second step. The length of time for this second step ranges from about 500 ms to 2 minutes, usually from about 500 ms to 1 minute and more usually from about 500 ms to 750 ms. Next, sample is applied to the sample application site of the test strip, while the portion of the meter continues to irradiated and reflected light from the bottom surface of the test strip is detected one or more times, including continuously, during this third step. The length of time for this third step typically ranges from about 250 ms to 1 second, usually from about 250 ms to 750 ms and more usually from about 250 ms to 500 ms. Finally, the region of the meter continues to be irradiated following application of the sample and reflectance values obtained one or more times, including continuously, until the end of the above described time period is reached. The length of time for this last step typically ranges from about 500 ms to 3 second, usually from about 500 ms to 2 seconds and more usually from about 500 ms to 1 second.

Once the above described reflectance data is obtained, it is compared to a reference in order to at least determine whether or not sample has been applied to the sample application site of the test strip, where in certain embodiments this comparison step yields information regarding whether a minimum or threshold amount of sample has been applied to the sample application site of the test strip. By reference is meant a data set or processed form thereof that indicates sample application onto a test strip surface, and in many embodiments the application of at least a threshold amount of sample. The reflectance data may or may not be processed prior to comparison with the reference, depending on the particular nature of the reference. Thus, in certain embodiments, the reflectance data is compared in raw form to the reference, where the reference is also present in a corresponding raw form of numerical values, e.g. reflectance amplitude vs. time. Alternatively, the reflectance data may be processed into a graph of reflectance over time, where the reference is a similar graph, and the two graphs may be compared. This comparison step may be performed manually or by a suitable automated data processing means, e.g. a computing means made up of suitable computing hardware and software. The above comparison step yields a sample present signal. In other words, following the above comparison, one obtains a reading as to whether sample has been applied to the test strip surface, and often whether a threshold amount of the sample is present on the step strip surface.

Systems

As summarized above, the above described methods find use with systems that are made up of disposable test strips and optical meters for reading these test strips. Each of these system components is now described in greater detail.

Test Strips

The test strips of the systems are fluidic devices that generally include a sample application area; a bladder, to create a suction force to draw the sample into the device; a measurement area, in which the sample may undergo a change in an optical parameter, such as light scattering; and a stop junction to precisely stop flow after filling the measurement area. Preferably, the test strips are substantially transparent over the measurement area, so that the area can be illuminated by a light source on one side and the transmitted light measured on the opposite side. Furthermore, at least the bottom surface of the test strip is non-porous.

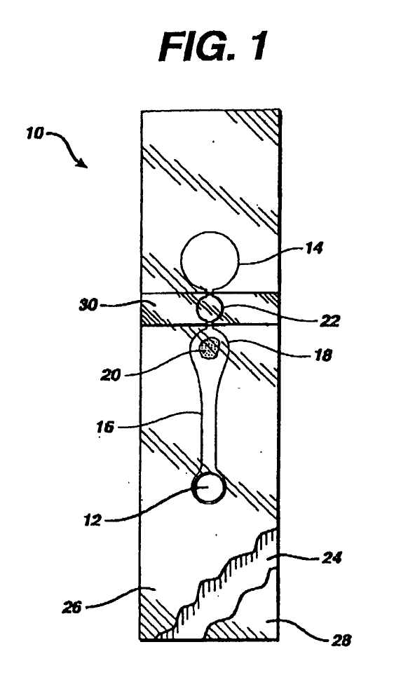

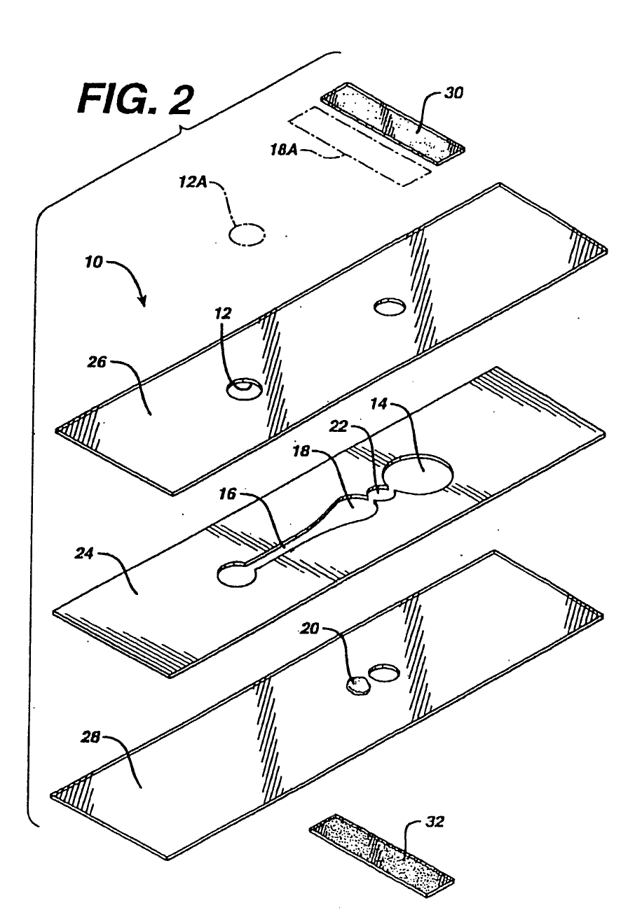

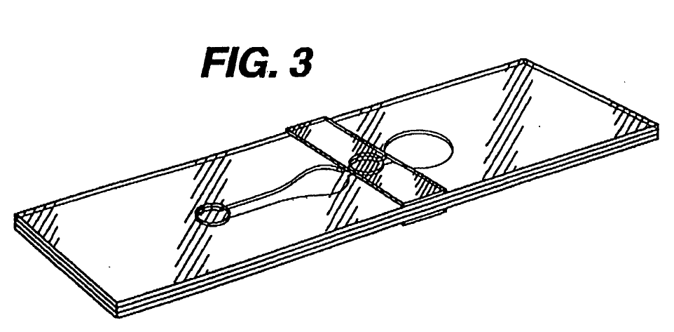

A representative bladder including test strip is shown in FIGS. 1, 2 and 3. FIG. 1 provides a plan view of representative device 10, while FIG. 2 provides an exploded view and FIG. 3 provides a perspective view of the same representative device. Sample is applied to sample port 12 after bladder 14 has been compressed. Clearly, the region of layer 26 and/or layer 28 that adjoins the cutout for bladder 14 must be resilient, to permit bladder 14 to be compressed. Polyester of about 0.1 mm thickness has suitable resilience and springiness. Preferably, top layer 26 has a thickness of about 0.125 mm, bottom layer 28 about 0.100 mm. When the bladder is released, suction draws sample through channel 16 to measurement area 18, which preferably contains a reagent 20. In order to ensure that measurement area 18 can be filled with sample, the volume of bladder 14 is preferably at least about equal to the combined volume of channel 16 and measurement area 18. If measurement area 18 is to be illuminated from below, layer 28 must be transparent where it adjoins measurement area 18.

As shown in FIGS. 1, 2, and 3, stop junction 22 adjoins bladder 14 and measurement area 18; however, a continuation of channel 16 may be on either or both sides of stop junction 22, separating the stop junction from measurement area 18 and/or bladder 14. When the sample reaches stop junction 22, sample flow stops. The principle of operation of stop junctions is described in U.S. Pat. No. 5,230,866, incorporated herein by reference.

As shown in FIG. 2, all the above elements are formed by cutouts in intermediate layer 24, sandwiched between top layer 26 and bottom layer 28. Preferably, layer 24 is double-sided adhesive tape. Stop junction 22 is formed by an additional cutout in layer 26 and/or 28, aligned with the cutout in layer 24 and sealed with sealing layer 30 and/or 32. Preferably, as shown, the stop junction comprises cutouts in both layers 26 and 28, with sealing layers 30 and 32. Each cutout for stop junction 22 is at least as wide as channel 16. Also shown in FIG. 2 is an optional filter 12A to cover sample port 12. The filter may separate out red blood cells from a whole blood sample and/or may contain a reagent to interact with the blood to provide additional information. A suitable filter comprises an anisotropic membrane, preferably a polysulfone membrane of the type available from Spectral Diagnostics, Inc., Toronto, Canada. Optional reflector 18A may be on, or adjacent to, a surface of layer 26 and positioned over measurement area 18. If the reflector is present, the device becomes a transflectance device.

The device pictured in FIG. 2 and described above is preferably formed by laminating thermoplastic sheets 26 and 28 to a thermoplastic intermediate layer 24 that has adhesive on both of its surfaces. The cutouts that form the elements shown in FIG. 1 may be formed, for example, by laser- or die-cutting of layers 24, 26, and 28. Alternatively, the device can be formed of molded plastic. Preferably, the surface of sheet 28 is hydrophilic. (Film 9962, available from 3M, St. Paul, Minn.) However, the surfaces do not need to be hydrophilic, because the sample fluid will fill the device without capillary forces. Thus, sheets 26 and 28 may be untreated polyester or other thermoplastic sheet, well known in the art. Similarly, since gravity is not involved in filling, the device can be used in any orientation. Unlike capillary fill devices that have vent holes through which sample could leak, these types of devices vent through the sample port before sample is applied, which means that the part of the strip that is first inserted into the meter is without an opening, reducing the risk of contamination.

Other fluidic device configurations are also possible, where such alternative device configurations include those that have: (a) a bypass channel; (b) multiple parallel measurement areas; and/or (c) multiple in series measurement areas; etc. In addition, the above described laminated structures can be adapted to injection molded structures.

Meters

The optical meters of the subject systems at least include a means for collecting reflectance data from a region of the optical meter that is occupied by a sample application location of a test strip when the test strip is present in the meter. This means for collecting reflectance data is generally made up of a light source and a detector. The light source is a source of visible light that is capable of irradiating or illuminating the region of the optical meter with light over a narrow range of wavelengths, where the wavelengths typically ranges from about 400 nm to 700 nm, usually from about 500 nm to 640 nm and more usually from about 550 nm to 590 nm. Any convenient light source may be employed, where suitable light sources include: LED, laser diode, filtered lamp and the like. Also part of the means for collecting reflectance data is a suitable detector that is capable of detecting reflected light, e.g. specular and/or diffusely reflected, from the region of the optical meter and then converting the collected light to an electrical signal. Any convenient detector may be employed, where suitable detectors include: photodiode, photodetector, phototransistor and the like. Preferably, the detection system is AC-modulated to provide immunity from the ambient noise and interference during use. In this implementation, the light source is turned on and off (“chopped”) at 2000 Hz. The smaller signal of interest from the detector, in the presence of much larger amplitude fluctuating noise, has the form of a square wave due to the modulating light source. The “chopped” signal with its noise is amplified and connected to the input of a synchronous detector. The synchronous detector consists of an integrating analog to digital converter (ADC) and a reference signal with the exact frequency and phase as the chopped light source. When the light source is on, the signal is integrated; when the light source is off, the integrator sits idle. The detection system can integrate the signal for a specified amount of time or take multiple average readings to reduce noise. A spectral blocking filter may also be included over the detector to reduce interference from ambient light.

In addition to the above means for obtaining reflectance data, the subject meters also generally include a means for comparing the reflectance data to a control value reference, as described above, to obtain a sample present signal. This means is generally a data processing means, such as a computing means made up of appropriate computing hardware and software, for comparing the reference data to the reference and generating a sample present signal.

The subject devices also generally include a means for actuating a bladder on the device in response to the sample present signal. Any convenient actuation means may be present, so long as it is capable of decompressing the bladder in response to the sample present signal.

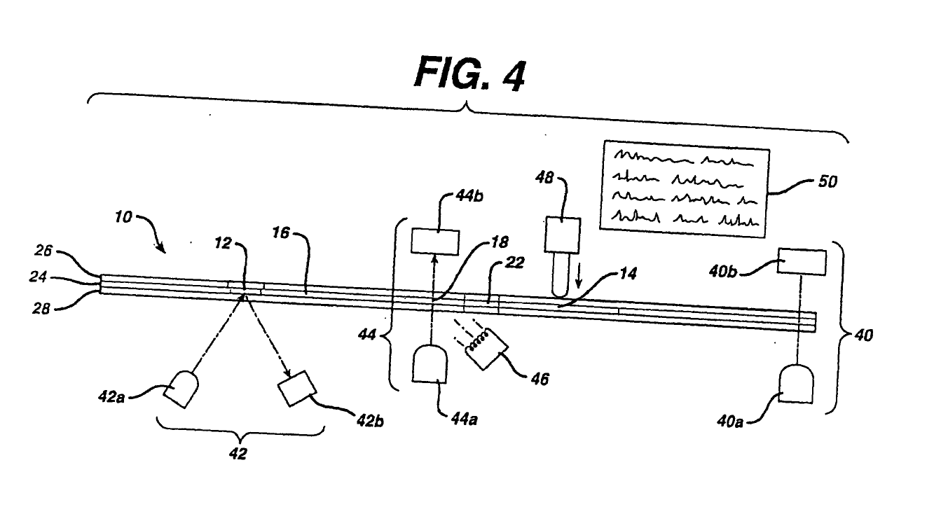

A representative meter is depicted in FIG. 4, where a representative test strip 10 is inserted into the meter. The meter shown in FIG. 4 includes strip detector 40 (made up of LED 40a and detector 40b), sample detector 42 (made up of light source 42a and detector 42b as described above), measurement system 44 (made up of LED 44a and detector 44b), and optional heater 46. The device further includes a bladder actuator 48. The bladder actuator is actuated by the strip detector 40 and the sample detector 42, as described above, such that when a strip is inserted into the meter and detected by the strip detector, the bladder actuator is depressed, and when the sample is added to the fluidic device or strip inserted into the meter, the bladder actuator is withdrawn so as to decompress the bladder and concomitantly pull sample into the measurement area of the device via the resultant negative pressure conditions. Also present is a meter display 50 that provides for an interface with the user.

Methods of Use

The above described sample detection methods and systems including the same, where the systems include the test strip holders and the subject meters, are suitable for use in a variety of analytical tests of biological fluids, such as determining biochemical or hematological characteristics, or measuring the concentration in such fluids of analytes such as proteins, hormones, carbohydrates, lipids, drugs, toxins, gases, electrolytes, etc. The procedures for performing these tests have been described in the literature. Among the tests, and where they are described, are the following: (1) Chromogenic Factor XIIa Assay (and other clotting factors as well): Rand, M. D. et al., Blood, 88, 3432 (1996); (2) Factor X Assay: Bick, R. L. Disorders of Thrombosis and Hemostasis: Clinical and Laboratory Practice. Chicago, ASCP Press, 1992.; (3) DRVVT (Dilute Russells Viper Venom Test): Exner, T. et al., Blood Coag. Fibrinol., 1, 259 (1990); (4) Immunonephelometric and Immunoturbidimetric Assays for Proteins: Whicher, J. T., CRC Crit. Rev. Clin Lab Sci. 18:213 (1983); (5) TPA Assay: Mann, K. G., et al., Blood, 76, 755, (1990).; and Hartshorn, J. N. et al., Blood, 78, 833 (1991); (6) APTT (Activated Partial Thromboplastin Time Assay): Proctor, R. R. and Rapaport, S. I. Amer. J. Clin. Path, 36, 212 (1961); Brandt, J. T. and Triplett, D. A. Amer. J. Clin. Path., 76, 530 (1981); and Kelsey, P. R. Thromb. Haemost. 52, 172 (1984); (7) HbA1c Assay (Glycosylated Hemoglobin Assay): Nicol, D. J. et al., Clin. Chem. 29, 1694 (1983); (8) Total Hemoglobin: Schneck et al., Clinical Chem., 32/33, 526 (1986); and U.S. Pat. No. 4,088,448; (9) Factor Xa: Vinazzer, H., Proc. Symp. Dtsch. Ges. Klin. Chem., 203 (1977), ed. By Witt, I; (10) Colorimetric Assay for Nitric Oxide: Schmidt, H. H., et al., Biochemica, 2, 22 (1995).

The above described fluid device/meter systems are particularly well suited for measuring blood-clotting time—“prothrombin time” or “PT time,” as more fully described in application Ser. Nos. 09/333,765, filed Jun. 15, 1999; and 09/356,248, filed Jul. 16, 1999, the disclosures of which are herein incorporated by reference. The modifications needed to adapt the device for applications such as those listed above require no more than routine experimentation.

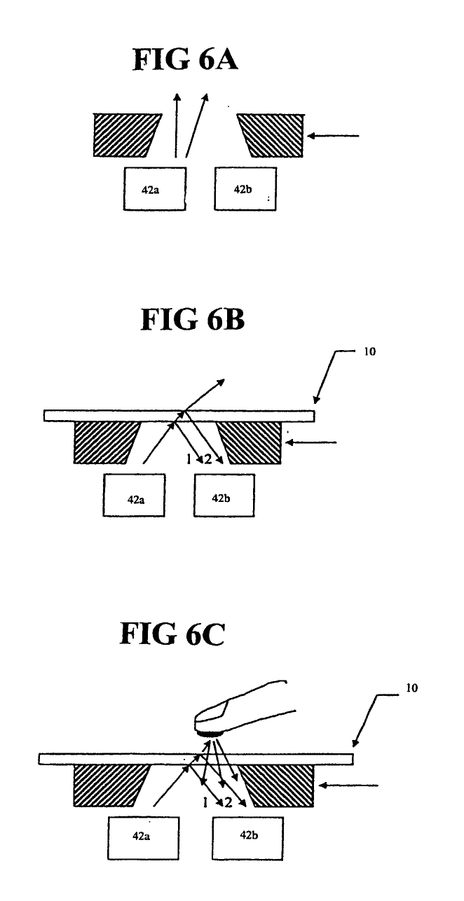

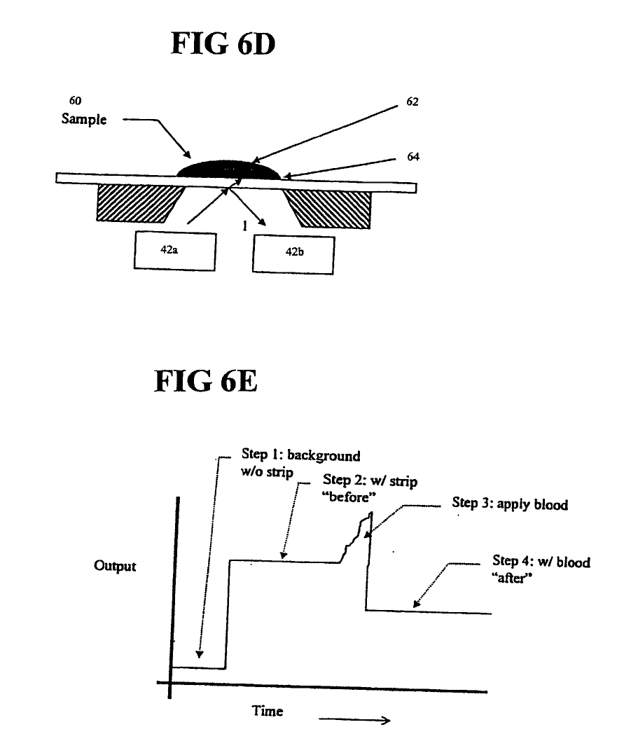

In using the above systems that include the subject sample application detection means, the first step the user performs is to turn on the meter, thereby energizing strip detector 40, sample detector 42, measurement system 44, and optional heater 46. The region of the meter that is occupied by the portion of the test strip that includes the sample application site is then irradiated with light from light source 42a and the detector detects little or no reflected light, thereby providing for a base reading, as shown in FIG. 6A. Next, test strip 10 is inserted through the opening of the meter and into the device. Preferably, the strip is not transparent over at least a part of its area, so that an inserted strip will block the illumination by LED 40a of detector 40b. (More preferably, the intermediate layer is formed of a non-transparent material, so that background light does not enter measurement system 44.) Detector 40b thereby senses that a strip has been inserted and triggers bladder actuator 48 to compress bladder 14. In addition, detector 42b detects a signal as shown in FIG. 6B which is used to establish a “before” reading. A meter display 50 then directs the user to apply a sample to sample port 12 as the third and last step the user must perform to initiate the measurement sequence. When a sample is introduced into the sample port as shown in FIG. 6C, more light is reflected to detector 42b. Following sample application, light detector 42b continues to detect light as shown in FIG. 6D in order to establish an after reading. In FIG. 6D, the radiation from the light source is absorbed 62 by the sample 60 and the reflected ray is reduced due to index matching at the sample fluid/film interface 64. The observed decrease in reflectance reading is related to index-matching at the sample fluid to strip interface. FIG. 6E provides a typical output signal of the detected sample application process described above. The reflectance data as represented in FIG. 6E is then compared to a reference to obtain a sample present signal, which sample present signal, in turn, signals bladder actuator 48 to release bladder 14. The resultant suction in channel 16 draws sample through measurement area 18 to stop junction 22. Light from LED 44a passes through measurement area 18, and detector 44b monitors the light transmitted through the sample as it is clotting. Analysis of the transmitted light as a function of time (as described below) permits a calculation of the PT time, which is displayed on the meter display 50. Preferably, sample temperature is maintained at about 37° C. by heater 46.

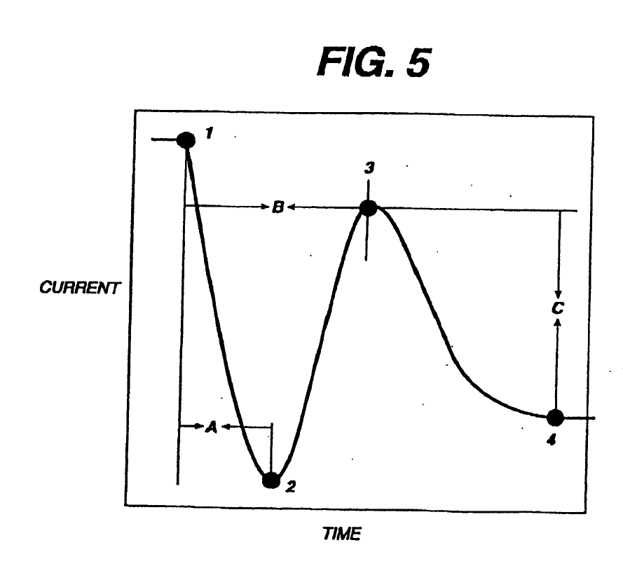

FIG. 5 depicts a typical “clot signature” curve in which the output from assay detector 44b is plotted as a function of time. Blood is first detected in the measurement area by 44b at time 1. In the time interval A, between points 1 and 2, the blood fills the measurement area. The reduction in output during that time interval is due to light scattered or absorbed by red cells and is thus an approximate measure of the hematocrit. At point 2, sample has filled the measurement area and is at rest, its movement having been stopped by the stop junction. The red cells begin to stack up like coins (rouleaux formation). The rouleaux effect allows increasing light transmission through the sample (and less scattering) in the time interval between points 2 and 3. At point 3, clot formation ends rouleaux formation and transmission through the sample reaches a maximum. The PT time can be calculated from the interval B between points 1 and 3 or between 2 and 3. Thereafter, blood changes state from liquid to a semi-solid gel, with a corresponding reduction in light transmission. The reduction in output C between the maximum 3 and endpoint 4 correlates with fibrinogen in the sample.

It is evident from the above results and discussion that the above describe invention provides a simple and accurate way to identify when a fluid sample has been applied to a test strip. The above described invention provides for a number of advantages, including: (a) the ability to differentiate between fluid sample applied to a test strip and other false trigger events, such as shadows or reflections caused by the finger or other application devices near the application area; (b) the ability to determine that minimum sample volume has been added to the test strip to ensure that air is not drawn into the strip by accident upon actuation; (c) the ability to operate under ambient lighting conditions with little or no light shield. As such, the subject invention represents a significant contribution to the art.

All publications and patents cited in this specification are herein incorporated by reference as if each individual publication or patent were specifically and individually indicated to be incorporated by reference. The citation of any publication is for its disclosure prior to the filing date and should not be construed as an admission that the present invention is not entitled to antedate such publication by virtue of prior invention.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A method for detecting the application of a fluid sample onto a non-porous test strip in an optical meter, said method comprising:
(a) obtaining reflectance data from a bottom side of said test strip opposite a fluid sample application site for a period ranging from a time prior to application of said fluid sample to said fluid sample application site to a time after application of said fluid sample to said fluid sample application site; and
(b) deriving from said reflectance data the application of said fluid sample onto said test strip.

2. The method according to claim 1, wherein said method comprises irradiating said bottom side of said test strip with visible light during said period.

3. The method according to claim 2, wherein said visible light is of a narrow range of wavelengths.

4. The method according to claim 1, wherein said non-porous test strip is fabricated from a polymeric material.

5. The method according to claim 1, wherein said reflectance data is obtained by the method comprising:
(i) introducing a test strip into said optical meter and irradiating a portion of said optical meter occupied by a bottom side of said test strip when said test strip is inserted into said meter with light of narrow range of wavelength;;
(ii) applying a fluid sample to said test strip while continuing to irradiate said portion; and
(iii) collecting reflected light from said portion during said steps (i) and (ii) for a period after said step (ii) to obtain said reflectance data.

6. The method according to claim 1, wherein the fluid sample is a physiological sample.

7. The method according to claim 6, wherein said physiological sample is blood.

8. A method for detecting that a physiological fluid sample has been applied to a nonporous polymeric test strip in an optical meter, said method comprising:
(a) obtaining reflectance data from a bottom side of said test strip opposite a fluid sample application site, wherein said reflectance data is obtained by the method comprising:
(i) introducing a test strip into said optical meter and irradiating said bottom side of said test strip with light of a narrow range of wavelengths;
(ii) applying said physiological fluid sample to said sample application site of said test strip while continuing to irradiate said portion; and
(iii) collecting reflected light from said portion during said steps (i) and (ii) and for a period after said step (ii) to obtain said reflectance data whereby said reflectance data is obtained; and
(b) deriving from said reflectance data that said fluid sample has been applied to said test strip surface.

9. The method according to claim 8, wherein said wavelengths range from about 550 to 590 nm.

10. The method according to claim 8, wherein said physiological sample is blood.

11. An optical meter that can determine when sample has been applied to the surface of a test strip inserted into it, said meter comprising:
(a) means for collecting reflectance data from a region of said meter occupied by a sample application location of said test strip when present in said meter, wherein said means comprises:
(i) a light source for irradiating said region of said meter; and
(ii) a detector for detecting reflected light from said region of said meter;
(b) means for comparing said reflectance data to a reference value to obtain a sample present signal; and
(c) means for actuating a fluid sample movement means of said test strip in response to said sample present signal.

12. The optical meter according to claim 11, wherein said light source is a source of visible light.

13. The optical meter according to claim 12, wherein said light has a wavelength ranging from about 550 nm to 590 nm.

14. The optical meter according to claim 11, wherein said meter further comprises said test strip.

15. An optical meter that can determine when sample has been applied to the surface of a test strip inserted into it, said meter comprising:
(a) means for collecting reflectance data from a region of said meter occupied by a sample application location of said test strip when present in said meter, wherein said means comprises:
(i) a light source for irradiating said region of said meter with light of wavelength ranging from about 550 to 590 nm; and
(ii) a detector for detecting reflected light from said region of said meter;
(b) means for comparing said reflectance data to a reference value to obtain a sample present signal; and
(c) means for actuating a fluid sample movement means of said meter in response to said sample present signal.

16. The optical meter according to claim 15, wherein said fluid movement means is a bladder depressing means.

17. The optical meter according to claim 15, wherein said test strip is present in said meter.

18. The optical meter according to claim 17, wherein said test strip is a non-porous test strip.
